(19) United States
(12) Patent Application Publication
(10) Pub. No.: US 2020/0140186 A1
(43) Pub. Date: May 7, 2020

(54) GROUND COFFEE DRIP BAG

(71) Applicants: Eui-Sun LEE, Gwangju-si, Gyeonggi-do (KR); Jung-Young LEE, Gwangju-si, Gyeonggi-do (KR)

(72) Inventors: Eui-Sun LEE, Gwangju-si, Gyeonggi-do (KR); Jung-Young LEE, Gwangju-si, Gyeonggi-do (KR)

(21) Appl. No.: 16/630,406

(22) PCT Filed: Oct. 27, 2017
(86) PCT No.: PCT/KR2017/012015

§ 371 Date: Jan. 10, 2020

(30) Foreign Application Priority Data
Aug. 24, 2017 (KR) 10-2017-0107099

(51) Int. Cl. B65D 85/804; A47J 31/02; B65D 65/42

(52) U.S. Cl. CPC B65D 85/8043; B65D 65/42; A47J 31/02

(57) ABSTRACT

A ground coffee drip bag includes a filter part for storing ground coffee beans, a hung part, and a lid part. The hung part, which is coupled to the top of the filter part, has an opening part formed in the center, and is mounted by being hung at the top of an average cup. The lid part is fitted into the opening part of the hung part, wherein the hung part has a first hung member which is formed from a circular cardboard having an opening part in the center, and to the bottom surface of which a first PET coating layer is applied. The hung part further has a second hung member which is formed from a circular cardboard having an opening part in the center, and to the top surface of which a second PET coating layer is applied. The first hung member and the second hung member, are respectively disposed on the top surface and the bottom surface of the top of the filter part, and may be adhered to the filter part by thermally bonding the first PET coating layer and the second PET coating layer.

### FIELD

The present invention relates to a ground coffee drip bag, and more particularly, to a ground coffee drip which is capable of being easily and conveniently used so as to drink an inherent taste and aroma of ground coffee.

### BACKGROUND

Conventionally, products for a ground coffee drip which are used to easily drink coffee beans are disclosed in Korean Utility Model Laid-Open Publication No. 20-1998-062752 (Patent Document 1) entitled “Disposable Coffee Bean Tea Bag” and Korean Patent Laid-Open Application No. 10-2003-0068874 (Patent Document 2) entitled “Throwaway Cup with Tea Bag and Manufacturing Method Thereof.”

Patent Document 1 discloses that a ground coffee bean bag in the form of storing ground coffee beans in a bag is immersed in a cup containing hot water, and, after the ground coffee beans melt, the bag is taken out and the coffee is consumed. However, this is cumbersome and inconvenient, and it is difficult to produce high quality coffee because of failing to stay the original taste of the coffee beans.

Further, Patent Document 2 discloses that a ground coffee bean bag in the form in which ground coffee beans are stored in a bag inside a predetermined cup is used. However, the use of the ground coffee bean bag is cumbersome and inconvenient, and there is a problem in that it is difficult to produce high quality coffee because of failing to stay the original taste of the coffee beans.

### RELATED ART

(Patent Document 0001) Korean Utility Model Laid-Open Publication No. 20-1998-042752 (Nov. 16, 1998)

(Patent Document 0002) Korean Patent Laid-Open Application No. 10-2003-0068874 (Aug. 25, 2003)

### SUMMARY

### Technical Problem

The present invention is directed to providing a ground coffee drip bag which has a simplified structure and which is capable of allowing drinking of high quality coffee in an easy and convenient manner.

### Technical Solution

One aspect of the present invention provides a ground coffee drip bag including a filter part configured to store ground coffee beans; a hung part coupled to an upper portion of the filter part, having an opening part formed at a center thereof, and hooked to and mounted on an upper portion of a regular cup; and a lid part inserted and fixed to the opening part of the hung part, wherein the hung part is made of a circular cardboard having the opening part formed at a center thereof and includes a first hung part material having a bottom surface on which a first poly(ethylene terephthalate) (PET) coating layer is applied and a second hung part material formed of a circular cardboard in which the opening part is formed at a center thereof and which has a top surface on which a second PET coating layer is applied, and in a state in which the first hung part material and the second hung part material are respectively disposed on a top surface and a bottom surface of an upper portion of the filter part, the first PET coating layer and the second PET coating layer are thermally bonded such that the first hung part material and the second hung part material are adhered to the filter part.

Further, a fitting protrusion may be formed on an inner circumferential surface of the opening part in the hung part, and a fitting groove to which the fitting protrusion is fitted and coupled may be formed on an outer circumferential surface of the lid part such that the lid part may be detachably coupled the opening part of the hung part; an L-shaped bent part may be formed on a bottom surface of the lid part along a circular edge thereof; and the fitting groove may be formed due to a space between the bent part and the lid part.

Further, an inclined surface may be formed at one side of the fitting protrusion; an inclined surface may be formed at one side of the fitting groove to be in contact with the inclined surface of the fitting protrusion to correspond thereto; and the lid part may be easily detached from the hung part due to the inclined surfaces of the fitting protrusion and the fitting groove.

### Advantageous Effects

In accordance with a ground coffee drip bag of the present invention, there is an effect in that a simplified structure is provided as well as a coffee drinker is capable of drinking high quality coffee in an easy and convenient manner.

Further, in accordance with the ground coffee drip bag of the present invention, when a lid part is inserted into an opening part of a hung part in the case of closing the lid part of the ground coffee drip bag, a fitting protrusion formed on an inner circumferential surface of the opening part of the hung part is fitted and coupled to a fitting groove formed on an outer circumferential surface of the lid part such that the lid part can be easily attach to the hung part. When the lid part is bent in an arrow direction in a state in which both ends of the hung part are held with a hand in the case of opening the lid part of the ground coffee drip bag, engagement between the fitting protrusion of the hung part and the fitting groove of the lid part is released such that the lid part can be easily separated from the hung part. Therefore, there is an effect in that the lid part of the ground coffee drip bag can be simply and easily detachable to be opened or closed.

Further, in accordance with the present invention, in a state in which a first hung part material and a second hung part material of the hung part are respectively disposed on a top surface and a bottom surface of an upper portion of the filter part, a first poly(ethylene terephthalate) (PET) coating layer and a second PET coating layer are thermally bonded such that the first hung part material and the second hung part material can be adhered to the filter part. As described above, there is an effect which is capable of easily and firmly attaching the hung part to the filter part through the thermal bonding with respect to the PET coating layers.

Further, in accordance with the present invention, an edge design of the hung part can be variously performed in a circular shape, a sunflower shape, a sawtooth shape, and the like to provide an aesthetic appearance of a product to be beautiful and it is also possible to print advertisements or a design text on the hung part. Consequently, there is an effect in that the coffee drinker can also obtain visual information through advertisements or designs printed on the hung part.

### BRIEF DESCRIPTION OF THE DRAWINGS

FIG. 1 is a perspective view illustrating a ground coffee drip bag according to one embodiment of the present invention.

FIG. 2 is an exploded perspective view illustrating a state in which a lid part of the ground coffee drip bag according to one embodiment of the present invention is separated.

FIG. 3 is a diagram illustrating the lid part of the ground coffee drip bag, FIG. 3A is a bottom perspective view of the lid part, and FIG. 3B is a side cross-sectional view thereof.

FIG. 4 is a diagram illustrating a coupling state of the lid part in the ground coffee drip bag according to one embodiment of the present invention.

FIG. 5 is a diagram illustrating a separation state of the lid part in the ground coffee drip bag according to one embodiment of the present invention.

FIG. 6 is a diagram illustrating a state in which poly(ethylene terephthalate) (PET) coating layers are applied onto a first hung part material and a second hung part material in the ground coffee drip bag according to one embodiment of the present invention.

FIG. 7 is a diagram illustrating a state in which the first hung part material and the second hung part material are attached to each other through thermal bonding.

FIG. 8 is a perspective view illustrating a ground coffee drip bag according to another embodiment of the present invention.

FIG. 9 is a perspective view illustrating a ground coffee drip bag according to still another embodiment of the present invention.

FIG. 10 is a diagram illustrating a use state of the ground coffee drip bag according to the present invention.

### DETAILED DESCRIPTION

Hereinafter, a ground coffee drip bag according to exemplary embodiments of the present invention will be described in detail below with reference to the accompanying drawings. For reference, to describe the present invention, when a detailed description of a known function or configuration related to the present invention is determined to unnecessarily obscure the gist of the present invention, the detailed description thereof will be omitted herein.

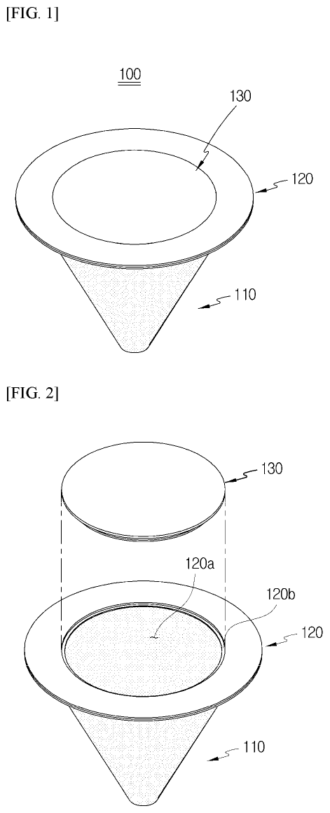

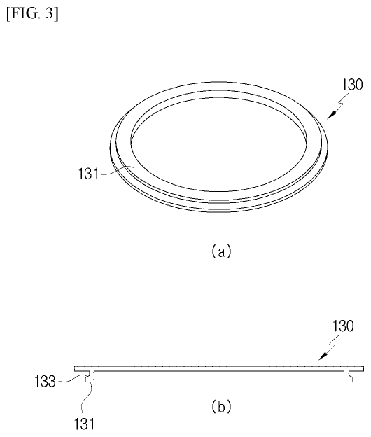

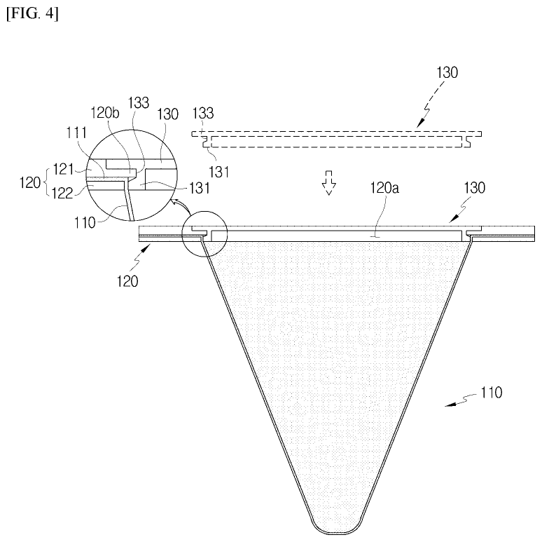

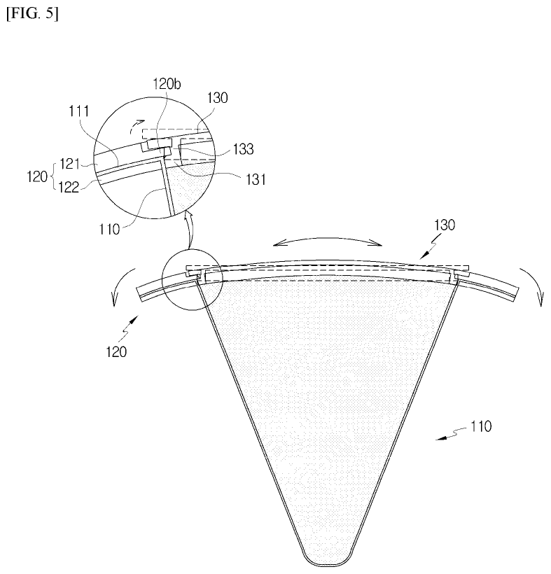

FIG. 1 is a perspective view illustrating a ground coffee drip bag according to one embodiment of the present invention, FIG. 2 is an exploded perspective view illustrating a state in which a lid part of the ground coffee drip bag according to one embodiment of the present invention is separated, FIG. 3 is a diagram illustrating the lid part of the ground coffee drip bag, FIG. 3A is a bottom perspective view of the lid part, FIG. 3B is a side cross-sectional view thereof. FIG. 4 is a diagram illustrating a coupling state of the lid part in the ground coffee drip bag according to one embodiment of the present invention, and FIG. 5 is a diagram illustrating a separation state of the lid part in the ground coffee drip bag according to one embodiment of the present invention.

As shown in FIGS. 1 to 5, a ground coffee drip bag 100 according to one embodiment of the present invention may include a filter part 110, a hung part 120, and a lid part 130.

The filter part 110 has a shape of which an upper surface is open such that ground coffee beans 1 (see FIG. 10) may be filled and stored in the filter part 110.

The filter part 110 may be made of a porous paper material such that hot water drips into the ground coffee beans 1 to filer coffee and thus the coffee flows down.

The hung part 120 may be attached to an upper portion 111 of the filter part 110 and hung on an upper end portion 11 of a regular cup 10, thereby being mounted on the regular cup 10. To this end, a diameter of the hung part 120 may be formed to be larger than that of the upper end portion 11 of the regular cup 10 such that the hung part 120 may be hung on the upper end portion 11 of the regular cup.

The hung part 120 may be formed in a circular shape, and a circular opening part 120a may be formed in a center of the hung part 120. The hung part 120 may be made of cardboard, but the present invention is not limited thereto, and the hung part 120 may be made of various other materials.

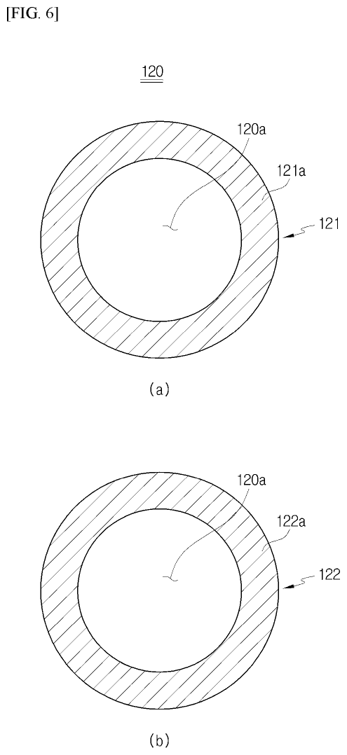

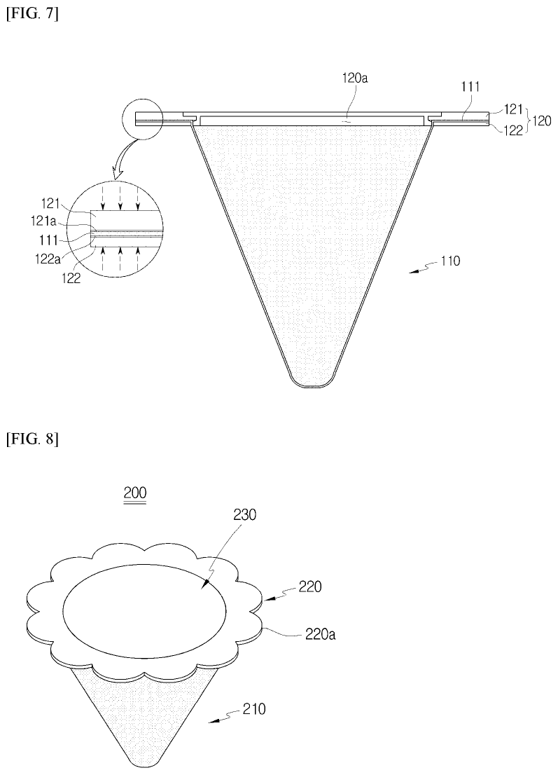

Further, in the present embodiment, a configuration of the hung part 120 in which an edge thereof is formed in a circular shape is exemplified, but the present invention is not limited thereto. The edge of the hung part 120 may be formed in a sunflower shape as shown in FIG. 6 or in a sawtooth shape as shown in FIG. 7. In addition to the above shape, the edge of the hung part 120 may be formed in various other shapes.

In the hung part 120, a fitting protrusion 120b may be formed on an inner circumferential surface of the opening part 120a. For example, the fitting protrusion 120b may formed to protrude in a circular rib shape along the inner circumferential surface of the opening part 120a.

The hung part 120 is formed of a circular cardboard with the opening part 120a formed at a center of the hung part 120. The hung part 120 may include a first hung member 121 adhered to the upper portion 111, and a second hung member 122 formed of the circular cardboard with the opening part 120a formed at a center of the hung part 120 and attached to a bottom surface of the lower portion 111 of the filter part 110 to correspond to the first hung member 121. That is, a first poly(ethylene terephthalate) (PET) coating layer 121a and a second PET coating layer 122a may be respectively applied to a bottom surface of the first hung member 121 and a top surface of the second hung member 122 to be bonded to a top surface and the bottom surface of the upper portion 111 of the filter part 110 through thermal bonding.

In the present embodiment, the configuration in which the fitting protrusion 120b is formed on the inner circumferential surface of the opening part 120a of the first hung member 121 has been illustrated, but the present invention is not limited thereto, and the fitting protrusion 120b may be formed on the outer circumferential surface of the opening part 120a of the second hung member 122.

Further, although not shown in the drawings, an advertisement design text and the like may be printed on the hung part 120.

The lid part 130 may be formed in a circular cardboard shape having a diameter corresponding to an inner diameter of the opening part 120a so as to be inserted into and coupled to the opening part 120a of the hung part 120.

A fitting groove 133 to which the fitting protrusion 120b of the hung part 120 is inserted and coupled is formed on an outer circumferential surface of the lid part 130 such that the lid part 130 may be detachably coupled to the opening part 120a of the hung part 120.

An L-shaped bent part 131 may be formed to protrude along a circular edge on a bottom surface of the lid part 130, and the fitting groove 133 may be formed due to a space between the bent part 131 and the lid part 130.

As shown in FIG. 4, when the lid part 130 is inserted into the opening part 120a of the hung part 120 in the case of closing the lid part 130 of the ground coffee drip bag 100, the fitting groove 120b formed on the inner circumferential surface of the opening part 120a of the hung part 120 is fitted in and coupled to the fitting groove 133 formed on the outer circumferential surface of the lid part 130 such that the lid part 130 may be easily attached to the hung part 120.

Further, as shown in FIG. 5, when both sides of the hung part 120 are bent in an arrow direction in a state of being held by hands in the case of opening the lid part 130 of the ground coffee drip bag 100, engagement between the fitting protrusion 120b of the hung part 120 and the fitting groove 133 of the lid part 130 is released such that the lid part 130 may be easily separated from the hung part 120.

Therefore, it is possible to detach the lid part 130 of the ground coffee drip bag 100 to be simply and easily opened or closed.

Further, an inclined surface is formed at one side of the fitting protrusion 120b of the hung part 120, and an inclined surface in contact with the inclined surface of the fitting protrusion 120b to correspond thereto is formed at one side of the fitting groove 133 of the lid part 130 such that the lid part 130 may be easily detached from the hung part 120 due to the inclined surfaces of the fitting protrusion 120b and the fitting groove 133.

Further, although not shown in the drawings, an advertisement design text and the like may be printed on the lid part 130.

FIG. 6 is a diagram illustrating a state in which PET coating layers are applied onto a first hung part material and a second hung part material in the ground coffee drip bag according to one embodiment of the present invention. FIG. 6A is a plan view of the first hung part material when viewed from the bottom surface, FIG. 6A is a plan view of the second hung part material when viewed from the top surface, and FIG. 7 is a diagram illustrating a state in which the first hung part material and the second hung part material are attached to each other through thermal bonding.

As shown in FIGS. 6 and 7, the first hung member 121 is formed of a circular cardboard having the opening part 120a formed at a center thereof, and the first PET coating layer 121a is applied to the bottom surface of the first hung member 121.

Further, the second hung member 122 is formed of a circular cardboard having the opening part 120a formed at a center thereof, and the second PET coating layer 122a is applied to the top surface of the second hung member 122.

In a state in which the first hung member 121 and the second hung member 122 of the hung part 120 are respectively disposed on the top surface and the bottom surface of the upper portion of the filter part 110, the first PET coating layer 121a is thermally bonded to the second PET coating layer 122a in an arrow direction such that the first hung member 121 and the second hung member 122 may be bonded to the filter part 110. As described above, the first hung member 121 and the second hung member 122 may be simply and firmly attached to the filter part 110 through the thermal bonding of the PET coating layers 121a and 122a.

FIG. 8 is a perspective view illustrating a ground coffee drip bag according to another embodiment of the present invention.

As shown in FIG. 8, a ground coffee drip bag 200 according to another embodiment of the present invention includes a filter part 210, a hung part 220, and a lid part 230. The ground coffee drip bag 200 is the same as that of one embodiment described with reference to FIGS. 1 to 7 except for forming an edge 220a of the hung part 220 in a sunflower shape, and thus a detailed description thereof will be omitted herein.

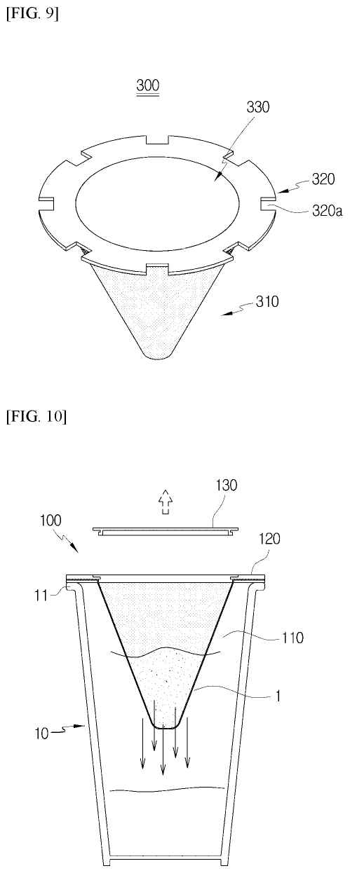

FIG. 9 is a perspective view illustrating a ground coffee drip bag according to still another embodiment of the present invention.

As shown in FIG. 9, a ground coffee drip bag 300 according to still another embodiment of the present invention includes a filter part 310, a hung part 320, and a lid part 330. The ground coffee drip bag 300 is the same as that of one embodiment described with reference to FIGS. 1 to 7 except for forming an edge 320a of the hung part 320 in a sawtooth shape, and thus a detailed description thereof will be omitted herein.

FIG. 10 is a diagram illustrating a use state of the ground coffee drip bag according to the present invention.

As shown in FIG. 10, the lid part 130 of the ground coffee drip bag 100 is separated first from the hung part 120 to open the opening part 120a of the hung part 120. In this case, as detailed described above in FIG. 5, when both sides of the hung part 120 are bent in an arrow direction in a state of being held by hands in the case of opening the lid part 130 of the ground coffee drip bag 100, engagement between the fitting protrusion 120b of the hung part 120 and the fitting groove 133 of the lid part 130 is released such that the lid part 130 may be easily separated from the hung part 120.

Next, in a state in which the lid part 130 is opened, the hung part 120 is hooked to the upper end portion 11 of the regular cup 10 to mount the ground coffee drip bag 100. In this case, since the diameter of the hung part 120 is formed to be larger than that of the upper end portion 11 of the regular cup 10, the hung part 120 may be hooked to and mounted on the upper end portion 11 of the regular cup 10.

Finally, in a state in which the ground coffee drip bag 100 is mounted on the upper end portion 11 of the regular cup 10, hot water drips onto the ground coffee beans 1 through the opening part 120a to allow coffee flows down such that a coffee drinker may drink high quality ground coffee.

Therefore, according to the ground coffee drip bag 100 of the present invention, the ground coffee drip bag 100 has a simplified structure as well as the coffee drinker is capable of drinking high quality ground coffee in an easy and convenient manner.

Further, an edge design of the hung part 120 may be variously performed in a circular shape, a sunflower shape, a sawtooth shape, and the like to provide an aesthetic appearance of a product to be beautiful and it is also possible to print advertisements or a design text on the hung part 120. Consequently, there is an effect in that the coffee drinker can also obtain visual information through advertisements or designs printed on the hung part 120.

In the present invention, a configuration of encapsulating the ground coffee beans 1 in the filter part 110 has been illustrated, but the present invention is not limited thereto, and a product in which the ground coffee beans 1 is not encapsulated in the filter part 110 may be sold. In this case, any ground coffee bean may be directly put into the filter part 110 when used, and hot water drips onto any ground coffee bean such that it is possible to drink high quality ground coffee.

While the embodiments of the present invention have been described with reference to the accompanying drawings, those skilled in the art can understand that the present invention can be implemented in other specific forms without departing from the technical spirit or the necessary features of the present invention. Therefore, it should be understood that the above-described embodiments are not restrictive but illustrative in all aspects. The scope of the present invention is defined by the appended claims rather than the detailed description, and it should be construed that all alternations or modifications derived from the meaning and scope of the appended claims and the equivalents thereof fall within the scope of the present invention.

1. A ground coffee drip bag, comprising:
a filter part configured to store ground coffee beans;
a hung part coupled to an upper portion of the filter part, having an opening part formed at a center thereof, and hooked to and mounted on an upper portion of a regular cup; and
a lid part inserted and fixed to the opening part of the hung part,
wherein the hung part is made of a circular cardboard having the opening part formed at a center thereof and includes a first hung part material having a bottom surface on which a first poly(ethylene terephthalate) (PET) coating layer is applied and a second hung part material formed of a circular cardboard in which the opening part is formed at a center thereof and which has a top surface on which a second PET coating layer is applied, and
in a state in which the first hung part material and the second hung part material are respectively disposed on a top surface and a bottom surface of an upper portion of the filter part, the first PET coating layer and the second PET coating layer are thermally bonded such that the first hung part material and the second hung part material are adhered to the filter part.

2. The ground coffee drip bag of claim 1, wherein:
a fitting protrusion is formed on an inner circumferential surface of the opening part in the hung part, and a fitting groove to which the fitting protrusion is fitted and coupled is formed on an outer circumferential surface of the lid part such that the lid part is detachably coupled the opening part of the hung part;
an L-shaped bent part is formed on a bottom surface of the lid part along a circular edge thereof; and
the fitting groove is formed due to a space between the bent part and the lid part.

3. The ground coffee drip bag of claim 2, wherein:
an inclined surface is formed at one side of the fitting protrusion;
an inclined surface is formed at one side of the fitting groove to be in contact with the inclined surface of the fitting protrusion to correspond thereto; and
the lid part is easily detached from the hung part due to the inclined surfaces of the fitting protrusion and the fitting groove.
